(19) United States
(12) Patent Application Publication
(10) Pub. No.: US 2008/0210050 A1
(43) Pub. Date: Sep. 4, 2008

(54) TRANSMISSION TO ENGINE ADAPTER KIT

(76) Inventor: David Allen Prettyman, Wellington, UT (US)

Correspondence Address: TRASK BRITT, P.O. BOX 2550, SALT LAKE CITY, UT, 84110, US

(21) Appl. No.: 12/036,841

(22) Filed: Feb. 25, 2008

Related U.S. Application Data
(60) Provisional application No. 60/945,009, filed on Jun. 19, 2007.

(51) Int. Cl. F16H 57/02

(52) U.S. Cl. 74/606 R

(57) ABSTRACT

Disclosed is a kit for coupling an incompatible engine and transmission. The kit includes a backing plate with an engine side and a transmission side. The backing plate has a crankshaft hole with a center axially aligned with a crankshaft flange extending beyond the rear face of the engine. The backing plate farther includes engine mounting holes aligned with a bolt pattern of the rear face of the engine. The backing plate also includes transmission mounting holes aligned with a bolt pattern of an engine end of a transmission bell housing of the transmission. The backing plate includes an access hole located between the pattern of the engine mounting holes and the pattern of the transmission mounting holes and sized to allow access to the interior of the transmission bell housing after the transmission bell housing has been attached to the backing plate.

### CROSS-REFERENCE TO RELATED APPLICATION

This application claims the benefit of the filing date of U.S. Provisional Patent Application 60/945,009 filed on Jun. 19, 2007, the contents of the entirety of which is incorporated by this reference.

### FIELD OF THE INVENTION

Embodiments of the invention relate generally to vehicle components. More particularly, embodiments of the invention relate to a transmission to engine adapter kit.

### BACKGROUND OF THE INVENTION

It is frequently desirable to replace an originally installed vehicle engine with an engine that is incompatible with the transmission of the vehicle. For example, it is often desirable to operate a vehicle in an underground mine. However, that necessitates using vehicles equipped with Mine Safety and Health Administration (MSHA) approved engines. Therefore, the vehicles must be retrofitted with a MSHA approved engine. Generally, the MSHA approved engine cannot be directly coupled to the existing vehicle transmission. Therefore, either the existing transmission has to be replaced, or an adapter must be used to appropriately couple the MSHA approved engine to the existing transmission.

One problem with some previously known adapters is that they increase the distance between the transmission and the engine so much that the new engine will not fit in the engine compartment of the vehicle. For example, a previously known adapter for coupling a MITSUBISHI Industrial S4S Series Diesel Engine to a 350 CHEVROLET Automatic Transmission utilizes an eight-to-nine inch thick flywheel housing to couple the engine with the transmission. For a small truck, due to the distance between the engine and the transmission, the front end of the truck would often have to be dismantled to increase the size of the engine compartment. Rebuilding the front of the truck wastes time and money and may result in a portion of the engine protruding from underneath the hood of the vehicle, which is aesthetically unappealing. Additionally, the previously known adapter utilized a two-to-three inch thick adapter plate between the engine flywheel and the torque converter of the transmission.

Additionally, when mounting a transmission to an engine, bolting the moving parts together is difficult. Generally speaking, an internal combustion engine has pistons which rotate a single crankshaft. A flange attached to the crankshaft extends beyond the rear face of the engine. One side of a disc called a flywheel is bolted to the crankshaft flange. The other side of the flywheel is attached to transmission components. For an automatic transmission, often the flywheel is bolted to a torque converter of the transmission. Thus, rotation of the crankshaft flange rotates the flywheel and the torque converter. The transmission includes a hollow transmission bell housing which surrounds and protects the torque converter. The transmission bell housing either bolts to the rear face of the engine or to a hollow flywheel housing that is bolted to the rear face of the engine.

The problem is that the flywheel and the torque converter are not correctly positioned until the transmission bell housing is correctly positioned relative to the engine. Thus, the transmission bell housing is bolted to the engine or flywheel housing before the torque converter is coupled to the flywheel. However, once the transmission bell housing is in position, there is no longer any way to reach the now surrounded flywheel and torque converter.

One previously-known adapter attempts to solve this problem with a flywheel housing that has a removable segment. The flywheel housing is bolted to the rear face of the engine. The transmission bell housing is bolted to the flywheel housing. The removable segment of the flywheel housing must then be unbolted to provide access to the flywheel. The flywheel may then be bolted to a torque converter and the removable segment bolted back in place. One difficulty with this complex adapter is that the flywheel housing must be cast in a mold or machined from a block. Therefore, manufacturing the adapter is expensive. Additionally, the flywheel housing increases the distance between the engine and the transmission by a thickness equal to the thickness of the flywheel housing.

A need exists for an adapter kit for coupling an incompatible engine and transmission that does not significantly increase the distance between the engine and the transmission. A need also exists for an adapter kit that provides access to the flywheel after a transmission bell housing is in place and that is relatively economical to manufacture.

### BRIEF SUMMARY OF THE INVENTION

Embodiments of the invention encompass a kit for coupling an incompatible engine and transmission. The kit may include a backing plate having an engine side and a transmission side. The backing plate may have a crankshaft hole with a center axially aligned with a crankshaft flange extending from a rear face of the engine. The crankshaft hole may have a diameter of sufficient width to receive a seal means for forming a seal between the crankshaft hole and the crankshaft flange. The backing plate may also include an engine mounting means for mounting the engine side of the backing plate to the rear face of the engine. The backing plate may also include transmission mounting means for mounting the transmission side of the backing plate to the engine end of a transmission bell housing of the transmission. At least a portion of the engine mounting means may be located between the transmission mounting means and the crankshaft hole.

Embodiments of the invention encompass a vehicle including an incompatible engine and transmission. The engine may have a crankshaft flange extending beyond a rear face of the engine. The transmission may have a transmission bell housing. The vehicle may include a backing plate with an engine side and a transmission side. The engine side may be bolted to the rear face of the engine via engine mounting holes in the backing plate. The transmission side may be bolted to the engine end of the transmission bell housing via transmission mounting holes in the backing plate. The backing plate may include a crankshaft hole having a center axially aligned with the crankshaft flange. The crankshaft hole may have a diameter of sufficient width to receive a seal means for forming a seal between the crankshaft hole and the crankshaft flange. The backing plate may further include an access hole located between the pattern of the engine mounting holes and the pattern of the transmission mounting holes to give tool access to the interior of the transmission bell housing. The engine compartment of the vehicle may not have to be enlarged to receive the incompatible engine.

### BRIEF DESCRIPTION OF THE SEVERAL VIEWS OF THE DRAWINGS

While the specification concludes with claims particularly pointing out and distinctly claiming that is regarded as the present invention, the advantages of this invention may be more readily ascertained from the following description of the invention when read in conjunction with the accompanying drawings in which:

FIG. 1 illustrates a vehicle utilizing an embodiment of a kit for coupling an incompatible engine and transmission;

FIG. 2 illustrates one embodiment of a backing plate for coupling an incompatible engine and transmission;

FIG. 3 illustrates the backing plate of FIG. 2 attached to an engine and embodiments of optional parts of a kit for coupling an incompatible engine and transmission;

FIG. 4 illustrates one embodiment of a holding means;

FIG. 5 illustrates the holding means of FIG. 4 attached to the backing plate of FIG. 2 and illustrates one embodiment of a crankshaft spacer means;

FIG. 6 illustrates one embodiment of a crankshaft spacer means;

FIG. 7 illustrates the crankshaft spacer means of FIG. 6 placed at the end of a crankshaft flange extending beyond the backing plate of FIG. 5;

FIG. 8 illustrates one embodiment of a flywheel;

FIG. 9 illustrates the flywheel of FIG. 8 attached to the crankshaft flange of FIG. 7;

FIG. 10 illustrates one embodiment of a starter spacer means; and

FIG. 11 illustrates the starter spacer means of FIG. 10 attached to the engine side of the backing plate of FIG. 2.

### DETAILED DESCRIPTION OF THE INVENTION

Embodiments of the invention may be used to couple an incompatible engine and transmission without significantly increasing the distance between the engine and the transmission. As used herein, the phrase “incompatible engine and transmission” encompasses an engine with a bolt pattern that does not align with the bolt pattern of a transmission. Embodiments of the invention may be used to retrofit a vehicle with an incompatible engine without increasing the size of the engine compartment. In certain embodiments of the invention, a flywheel can be accessed in order to bolt a torque converter to the flywheel even after the transmission bell housing has already been bolted in place.

Reference will now be made to the drawings. Like elements are identified with like reference numerals. The drawings are not necessarily to scale.

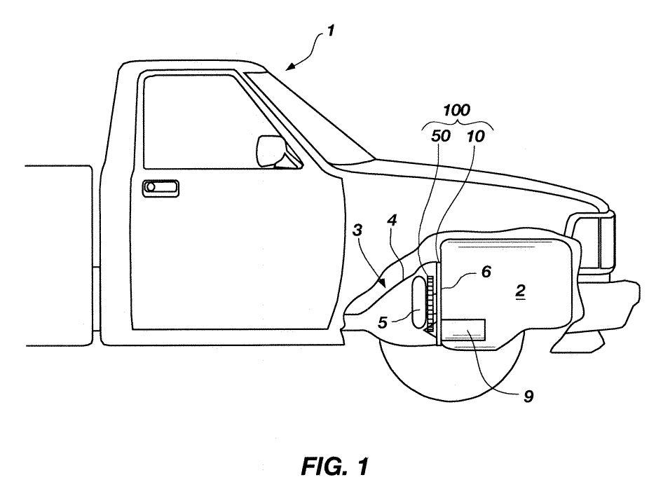

Referring to the drawings, FIG. 1 illustrates vehicle 1 including adapter kit 100 coupling engine 2 to transmission 3. Often, transmission 3 may be the transmission originally supplied by the manufacturer of vehicle 1. However, transmission 3 may be installed at the same time as engine 2. Transmission 3 may include transmission bell housing 4 and torque converter 5. In this embodiment, adapter kit 100 includes backing plate 10 and flywheel 50. Rear face 6 of engine 2 may be attached to backing plate 10. Backing plate 10 may also be attached to transmission bell housing 4. Torque converter 5 may be attached to flywheel 50. In certain embodiments, the distance between engine 2 and transmission 3 may be 3/8 inch or 1/2 inch.

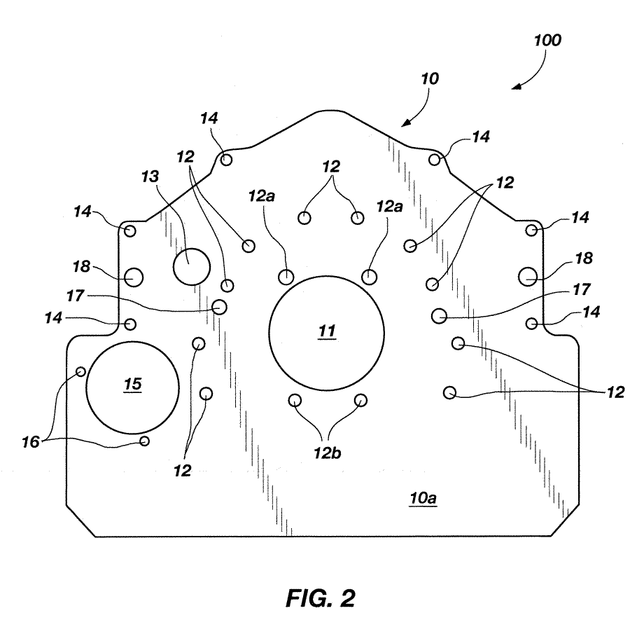

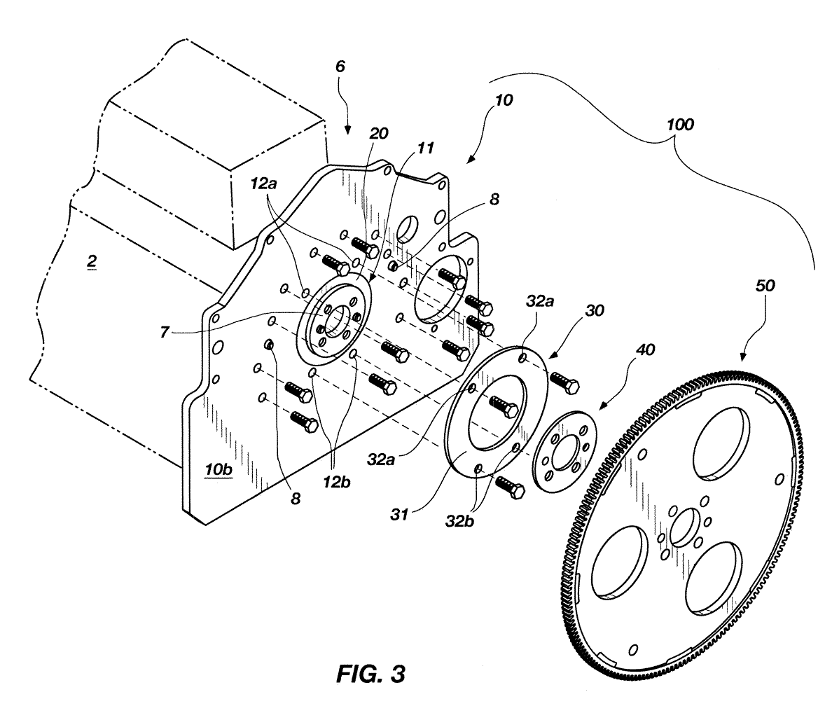

Referring to FIG. 2, adapter kit 100 may include backing plate 10. Backing plate 10 may couple rear face 6 of engine 2 to transmission bell housing 4. Backing plate 10 comprises a flat plate with an engine side 10a and transmission side 10b (see FIG. 3). Backing plate 10 may include engine mounting means for coupling backing plate 10 to engine 2. For example, backing plate 10 may include engine mounting holes 12, 12a, and 12b and engine guide holes 17. Engine mounting holes 12, 12a, and 12b may align with a bolt pattern (not shown) of rear face 6 of engine 2. The bolt pattern of rear face 6 may include threaded bores in rear face 6 for receiving bolts. Engine mounting holes 12, 12a, and 12b may be any diameter necessary for receiving the appropriate mounting bolts. Engine mounting holes 12a and 12b may be located around the perimeter of crankshaft hole 11. Engine mounting holes 12a may be larger than engine mounting holes 12b, if necessary. Engine mounting holes 12, 12a, and 12b may be smooth bores without any threads. Bolts may be inserted through engine mounting holes 12 and threaded into the threaded bores (not shown) in rear face 6 to secure backing plate 10 to engine 2. Engine guide holes 17 may align with and receive guide pins 8 that extend from rear face 6 and thereby assist in aligning engine mountings holes 12, 12a, and 1b with the respective threaded bores in rear face 6.

Backing plate 10 may include transmission mounting means for coupling backing plate 10 to transmission 3. For example, backing plate 10 may include transmission mounting holes 14 that align with a bolt pattern of the engine end of transmission bell housing 4. Transmission mounting holes 14 may be threaded. The engine end of transmission bell housing 4 may include smooth bores arranged around the perimeter of the engine end (i.e., the bolt pattern) that allow transmission 3 to be coupled to equipment. Bolts may be inserted through the smooth bores of the engine end of transmission bell housing 4 and threaded into transmission mounting holes 14 to couple backing plate 10 to transmission 3. Transmission mounting holes 14 may be any diameter necessary to work with the bolt pattern of the engine end of transmission bell housing 4. Additionally, backing plate may include transmission guide holes 18 for receiving guide pins (not shown) extending from the engine end of transmission bell housing 4.

In certain embodiments, backing plate 10 may be used when transmission bell housing 4 is wider than rear face 6 of engine 2. The outer dimensions of backing plate 10 may be matched with the outer dimensions of the engine end of transmission bell housing 4. Therefore, at least a portion of the engine mounting means may be located between the transmission mounting means and crankshaft hole 11. For example, the pattern of engine mounting holes 12 may be located within the pattern of transmission mounting holes 14.

In certain embodiments, backing plate 10 may have a thickness of about ⅜ inch to about ½ an inch. The thickness of backing plate 10 may determine the distance between engine 2 and transmission 3. Therefore, the distance between engine 2 and transmission 3 may be about ⅜ inch to about ½ inch. It should be understood that the thickness of backing plate 10 may be varied and, thus, the distance between engine 2 and transmission 3 may be varied.

Backing plate 10 may include access hole 13. Access hole 13 may be sized and located in backing plate 10 so as to allow tool access to the interior of transmission bell housing 4 after transmission bell housing 4 has been bolted to backing plate 10. Access hole 13 may be located between the pattern of engine mounting holes 12 and the pattern of transmission mounting holes 14. Thus, flywheel 50 may be accessed through access hole 13 to bolt flywheel 50 to torque converter 5. Access hole 13 provides a simple solution to the problem of how to couple transmission components to a flywheel after a transmission bell housing has been correctly positioned. Access hole 13 may be used for more than coupling transmission components to flywheel 50. In one embodiment, the diameter of access hole 13 is 1.5 inch. Access hole 13 may be plugged when not in use. For example, a rubber or plastic plug may be inserted in access hole 13.

Backing plate 10 may include starter hole 15 to allow starter 9 (see FIG. 1) to engage the ring gear of flywheel 50. Backing plate 10 may include starter mounting holes 16 aligned with the mounting bolts of starter 9. It should be understood that starter hole 15 may be sized and shaped to mate with a desired starter 9.

Backing plate 10 may include crankshaft hole 11 for receiving crankshaft flange 7, as depicted in FIG. 3. FIG. 3 illustrates one embodiment of backing plate 10 attached to engine 2. FIG. 3 also illustrates optional parts of adapter kit 100, holding means 30, crankshaft spacer 40, and flywheel 50. These parts will be discussed individually below. Referring to backing plate 10, crankshaft hole 11 may be axially aligned with crankshaft flange 7. Crankshaft flange 7 may extend beyond rear face 6 of engine 2 and through crankshaft hole 11. Crankshaft hole 11 may be of sufficient width to not interfere with the rotation of crankshaft flange 7.

As depicted in FIG. 3, adapter kit 100 may include seal means 20 for forming a seal between crankshaft hole 11 and crankshaft flange 7. Seal means 20 may prevent leakage of internal engine lubricants around crankshaft flange 7. Seal means 20 may be the rear main seal originally supplied by the manufacturer of engine 2. Rear main seals are known in the art and, thus, will not be discussed in more detail herein. In one example of using an existing rear main seal for seal means 20, the manufacturer of engine 2 may supply a flywheel housing or other plate attached to rear face 6 of engine 2. Seal means 20 may be the rear main seal originally supplied to form a seal between crankshaft flange 7 and the flywheel housing or other plate supplied by the manufacturer. The flywheel housing or other plate bolted to rear face 6 of engine 2 may be removed and backing plate 10 bolted to rear face 6. Crankshaft hole 11 may be sized so that the originally supplied rear main seal may be used to form a seal between crankshaft flange 7 and crankshaft hole 11.

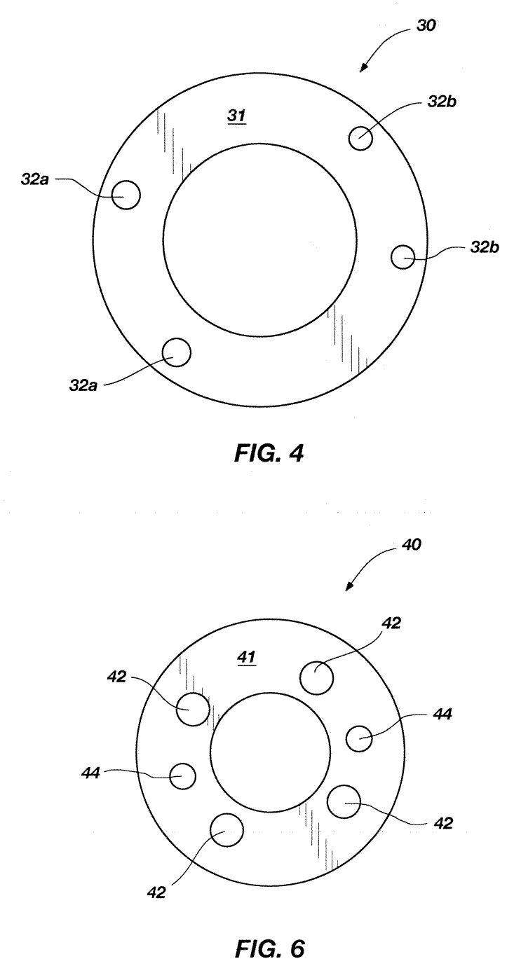

Referring to FIG. 4, in conjunction with seal means 20, adapter kit 100 may optionally include holding means 30 for holding seal means 20 in place. Holding means 30 may prevent seal means 20 from potentially sliding out from between crankshaft flange 7 and crankshaft hole 11. Axial movement of seal means 20 may allow engine lubricants to leak out of engine 2. Seal means 20 may tend to axially slide if crankshaft hole 11 is not precisely machined to be perpendicular to engine side 10a and transmission side 10b (e.g., if crankshaft hole 11 has a taper). If crankshaft hole 11 is precisely cut, then holding means 30 may not be necessary. Holding means 30 may include means for attaching holding means 30 to backing plate 10.

Holding means 30 may include an annular ring member 31 that is attached (e.g., bolted) to backing plate 10 and overlaps at least a portion of seal means 20 so as to keep it from moving. Annular ring 31 may have an inner diameter able to circumscribe crankshaft flange 7 without contacting crankshaft flange 7. Annular ring member 31 may have an outer diameter wider than the diameter of crankshaft hole 11. Thus, holding means 30 may prevent seal means 20 from working out from between crankshaft hole 11 and crankshaft flange 7 while crankshaft flange 7 is rotating during the operation of engine 2. It should be understood that the outer perimeter of holding means 30 may be shapes other than circular. Holding means 30 may have any thickness that does not interfere with other components of adapter kit 100. For example, holding means 30 may have a thickness equal to or less than the distance between transmission side 10b of backing plate 10 and the end of crankshaft flange 7.

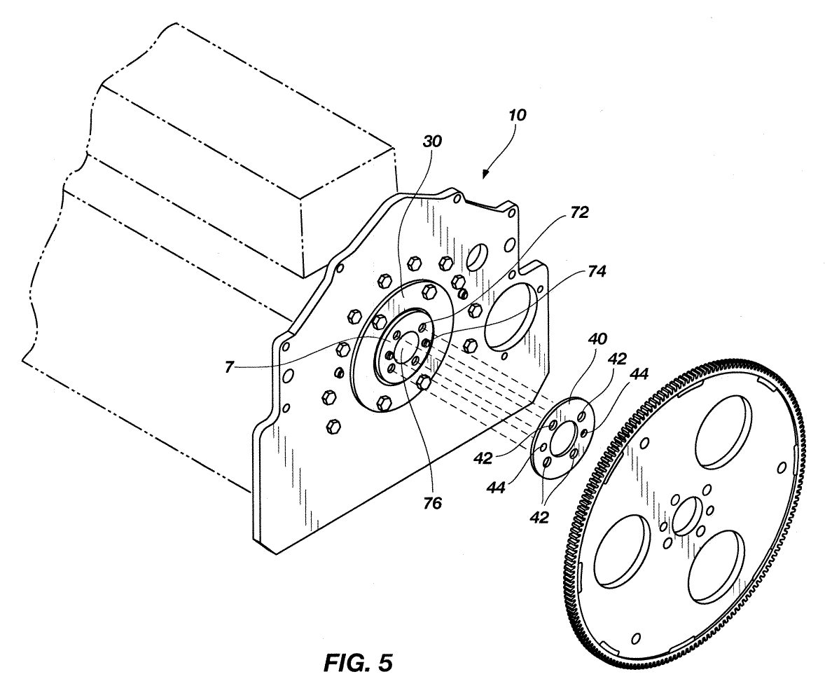

As an example of a means for attaching holding means 30 to backing plate 10, annular ring member 31 may have two mounting holes 32a and two mounting holes 32b. As depicted in FIG. 3, mounting holes 32a and 32b may align with engine mounting holes 12a and 12b, respectively. FIG. 5 illustrates holding means 30 fastened to backing plate 10. Mounting holes 32a may be larger than mounting holes 32b. The diameter of mounting holes 32a and 32b may be determined by the size of engine mounting holes 12a and 12b, respectively. Bolts may be inserted through mounting holes 32a and 32b and through engine mounting holes 12a and 12b and then threaded into rear face 6 of engine 2. Therefore, the same bolts used to secure holding means 30 against backing plate 10 may also help to secure backing plate 10 to rear face 6.

Holding means 30 may also aid in installation of seal means 20. After backing plate 10 is attached to rear face 6 of engine 2, then it may be necessary to install seal means 20. In the embodiment where seal means 20 includes a rear main seal, holding means 30 may be used to uniformly push the rear main seal into place. The bolts inserted through mounting holes 32a and 32b and threaded into rear face 6 may be uniformly tightened, uniformly pushing holding means 30 against backing plate 10, and thereby uniformly pushing the rear main seal into place.

As depicted in FIG. 5, crankshaft flange 7 may include means for attaching flywheel 50 to crankshaft flange 7. For example, crankshaft flange 7 may include four threaded bores 72 and two guide pins 74. Threaded bores 72 may be configured for receiving bolts. Guide pins 74 may be configured for guiding the alignment of a flywheel. Crankshaft flange 7 may also include hub 76 for receiving the shaft (not shown) of a torque converter. It should be understood that crankshaft flange 7 may be any crankshaft flange known in the art.

Referring to FIGS. 5 through 7, adapter kit 100 may optionally include crankshaft spacer means 40 for axially spacing flywheel 50 for attachment to any necessary transmission components. For example, crankshaft spacer means 40 may space flywheel 50 from the end of crankshaft flange 7 to allow for the necessary travel of torque converter 5 attached to flywheel 50. Crankshaft spacer means 40 may mate with crankshaft flange 7. Upon installation, crankshaft spacer means 40 may be sandwiched between crankshaft flange 7 and flywheel 50.

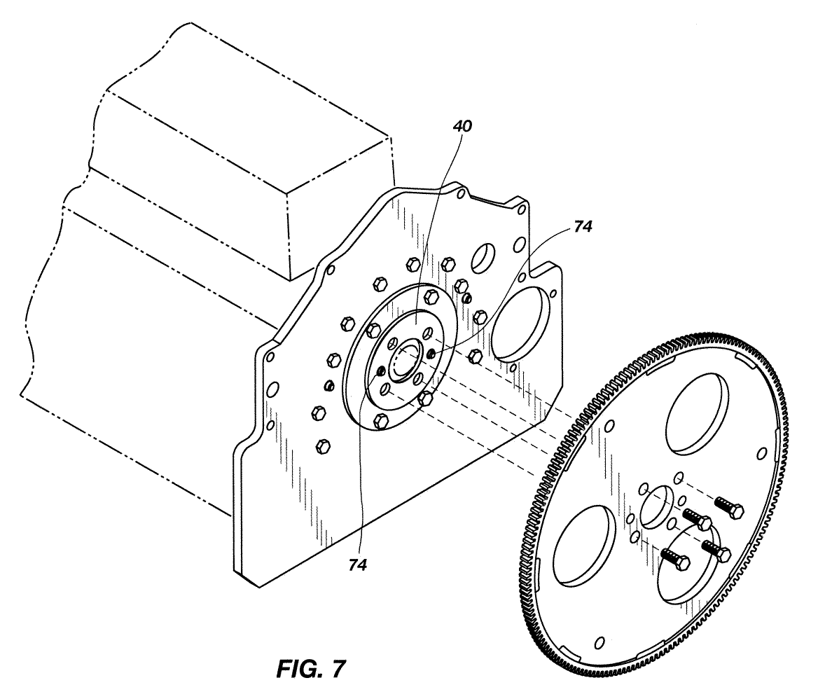

Crankshaft spacer means 40 may match the dimensions of crankshaft flange 7. For example, crankshaft spacer means 40 may include annular ring member 41. Annular ring member 41 may include an outer diameter equal to the outer diameter of crankshaft flange 7. The inner diameter of annular ring member 41 may be equal to or larger than the diameter of hub 76 of crankshaft flange 7. As depicted in FIG. 5, annular ring member 41 may include four crankshaft mounting holes 42 that align with threaded bores 72 of crankshaft flange 7. Annular ring member 41 may include two guide holes 44 that align with guide pins 74. FIG. 7 illustrates placement of crankshaft spacer means 40 at the end of crankshaft flange 7. It should be understood that crankshaft spacer means 40 may be configured as necessary to mate with crankshaft flange 7 so as to appropriately space flywheel 50 from the end of crankshaft spacer 7.

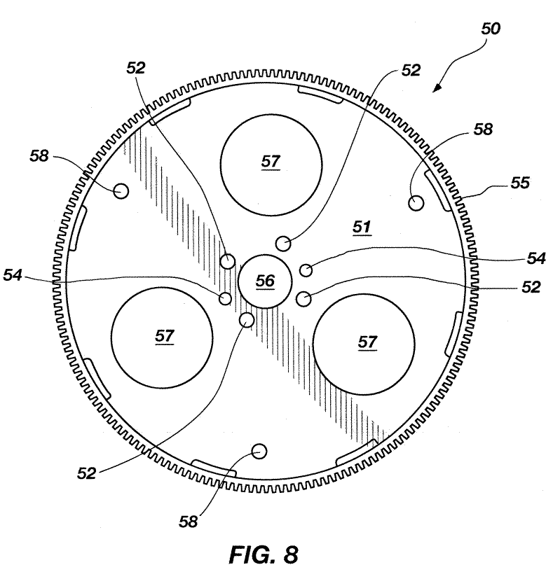

Referring to FIGS. 7 through 9, adapter kit 100 may optionally include flywheel 50. FIG. 7 illustrates alignment of flywheel 50 with crankshaft flange 7 and crankshaft spacer means 40. As depicted in FIG. 8, flywheel 50 may include disc member 51. The circumference of disc member 51 may be bounded by ring gear 55. Ring gear 55 may be welded to disc member 51. The diameter of disc member 51 may be governed by the dimensions of transmission 3. Flywheel 50 needs to be small enough to fit within transmission bell housing 4, but of large enough diameter to mate with torque converter 5.

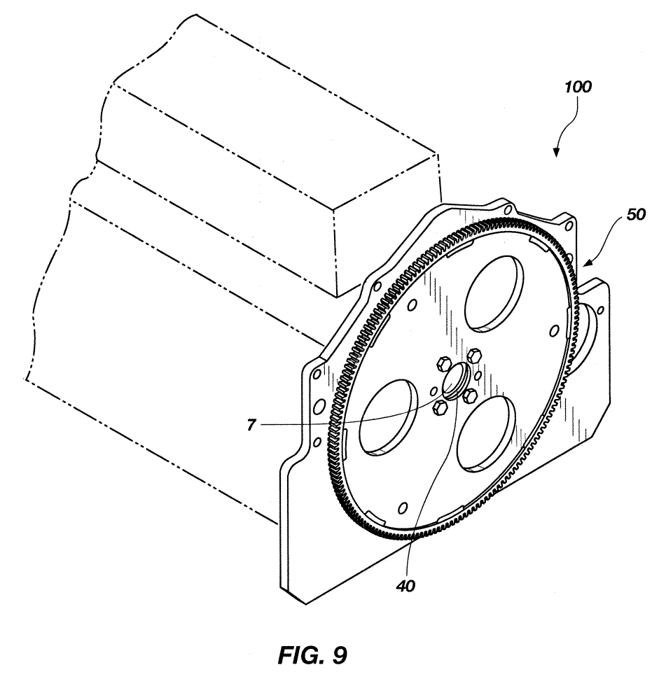

Disc member 51 may include means for coupling flywheel 50 to crankshaft flange 7. For example, disc member 51 may include four mounting holes 52 and two guide holes 54. Mounting holes 52 may align with threaded bores 72 of crankshaft flange 7. Guide holes 54 may align with guide pins 74 of crankshaft flange 7. Bolts may be inserted through mounting holes 52 and threaded into threaded bores 72 to secure flywheel 50 to crankshaft flange 7. When crankshaft spacer means 40 is present, crankshaft spacer means 40 may be sandwiched between the end of crankshaft flange 7 and flywheel 50. FIG. 9 depicts flywheel 50 coupled to crankshaft spacer means 40 and crankshaft flange 7. It should be understood that flywheel 50 may include any necessary means for coupling flywheel 50 to crankshaft flange 7.

Disc member 51 may include means for coupling flywheel 50 to torque converter 5 of transmission 3. For example, disc member 51 may include torque converter mounting holes 58 for receiving bolts for securing torque converter 5 to flywheel 50. Disc member 51 may also include a central hole 56 to allow the central shaft of torque converter S to be inserted into hub 76 of crankshaft flange 7. The diameter of central hole 56 may be at least as large as the diameter of hub 76. Disc member 51 may also include holes 57 for reducing the weight of flywheel 50. It should be understood that flywheel 50 may include any necessary means for coupling flywheel 50 to torque converter 5.

Flywheel 50 may be as thick as necessary to appropriately mate with torque converter 5. As discussed previously, crankshaft spacer means 40 may also be used to appropriately space flywheel 50 relative to torque converter 5.

Depending upon engine 2 and transmission 3, the flywheel originally supplied by the engine manufacturer may fit within transmission bell housing 4. In such situations, the original flywheel may be flywheel 50. Thus, it would not be necessary to include flywheel 50 with adapter kit 100.

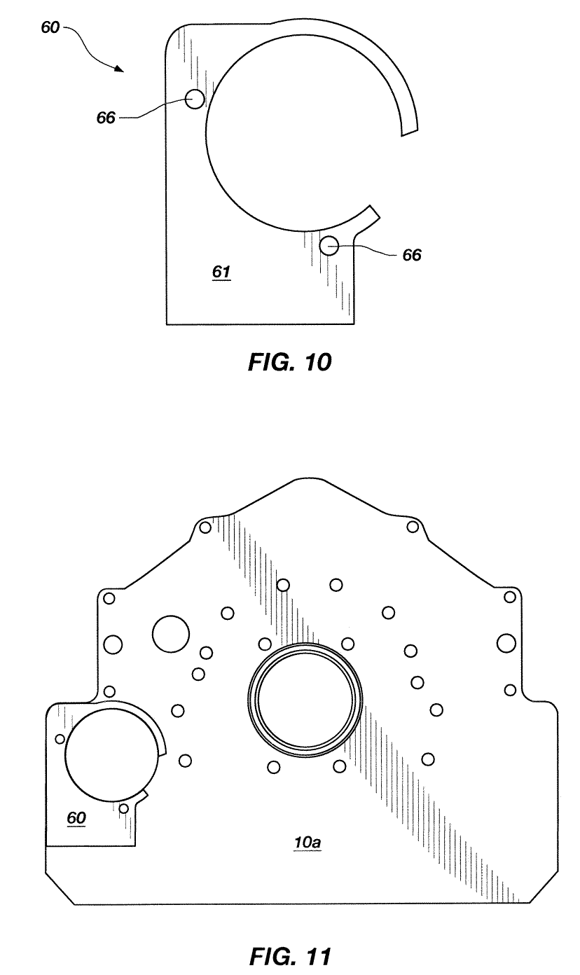

Referring to FIG. 10, one embodiment of adapter kit 100 may also include starter spacer means 60 for appropriately aligning starter 9 (see FIG. 1) with ring gear 55 of flywheel 50. The starter pinion gear of starter 9 needs to mesh with ring gear 55. As the motor of starter 9 rotates the starter pinion gear, flywheel 50 is rotated, which starts engine 2. Starter spacer means 60 may be used with starter hole 15 of backing plate 10 to change the longitudinal placement of the starter pinion gear inserted though starter hole 15 and, thus, allow the starter pinion gear to mesh with ring gear 55.

Starter spacer means 60 may include means for mounting starter 9. For example, starter spacer means 60 may include plate member 61 that has a “C” shape. The inner perimeter of the closed portion of the “C” shape may be equal to the inner radius of starter hole 15. The “C” shape may be wide enough that the mounting surface of a desired starter may be solidly mounted to starter spacer means 60. Plate member 61 may be any thickness necessary to appropriately align (i.e., longitudinally space) the desired starter with ring gear 55 of flywheel 50. It should be understood that one of ordinary skill in the art would be able to determine the necessary thickness of plate member 61 to appropriately align the desired starter 9.

Plate member 61 may include starter mounting holes 66 aligned with starter mounting holes 16 of backing plate 10. Bolts may extend through starter mounting holes 16 and starter mounting holes 66 to secure the starter to backing plate 10 and starter spacer means 60. As depicted in FIG. 11, starter spacer means 60 may be attached to engine side 10a of backing plate 10. For example, starter spacer means 60 may be welded to engine side 1 Oa.

Starter 9 may be the starter originally specified by the manufacturer of engine 2. However, starter 9 may be a starter selected to work with adapter kit 100 and transmission 3. For example, the pinion gear of the originally specified starter may not fit within transmission bell housing 4. Thus, it may be necessary to use a starter with a smaller pinion gear. Regardless of whether starter 9 is the originally specified starter or a different starter, it may be necessary to use starter spacer means 60 to appropriately align the starter pinion gear with ring gear 55. The distance between flywheel 50 and engine 2 may be different from that originally specified by the manufacturer of engine 2. Therefore, regardless of the starter 9 used, starter spacer means 60 may be necessary. It should be understood that starter 9 may be any starter compatible with adapter kit 100, engine 2, and transmission bell housing 4.

### EXAMPLE 1

Turning now to a non-limiting example of utilizing adapter kit 100, in one embodiment, vehicle 1 may be a small pickup truck with a 350 CHEVROLET automatic transmission, regular or RV rated (hereinafter the “350 transmission”). The engine has been removed and it is desired to replace it with a MITSUBISHI industrial S4S series diesel engine (hereinafter the “S4S engine”). The motor mounts within the engine compartment are modified to mate with the S4S engine. The S4S engine may originally have a flywheel housing bolted to the rear face of the engine. The S4S engine may also come with a flywheel attached to the crankshaft flange. The flywheel housing (if present), the flywheel (if present), and rear main seal supplied with the S4S engine are removed. The bolt pattern of the rear face of the S4S engine does not align with the bolt pattern of the engine end of the 350 transmission bell housing. Backing plate 10 is configured with engine mounting holes 12 aligned with the bolt pattern of the rear face of the S4S engine. Backing plate 10 is bolted to the rear face of the S4S engine.

Crankshaft hole 11 of backing plate 10 has a diameter of 4½ inch to receive the previously removed rear main seal and crankshaft flange 7. The rear main seal is placed between the crankshaft flange of the S4S engine and the interior surface of crankshaft hole 11. In this example, the rear main seal supplied with the S4S engine constitutes seal means 20. Holding means 30 is sized to cover the rear main seal and is then bolted against backing plate 10 to prevent axial movement of the rear main seal. Holding means 30 has a thickness of about ⅛ inch.

Crankshaft spacer means 40 is sandwiched between flywheel 50 and the crankshaft flange of the S4S engine. Flywheel 50 is then bolted to the crankshaft flange. Flywheel 50 has a diameter of about 13¼ inch in order to fit within the transmission bell housing of the 350 transmission. Crankshaft spacer means 40 has a thickness of about ¼ of an inch and plate member 51 of flywheel 50 has a thickness of about ⅜ of an inch to appropriately axially space flywheel 50 relative to the torque converter of the 350 transmission.

The starter originally specified for the S4S engine will not fit within the 350 transmission bell housing. A Delco starter with a modified narrower pinion gear is utilized. The modified pinion gear mates with flywheel 50 and fits within the 350 transmission bell housing. Starter spacer means 60 is welded to engine side lOa of backing plate 10. Starter spacer means 60 has a width of about ½ of an inch in order to appropriately mesh the pinion gear of the chosen starter with ring gear 55 of flywheel 50.

Transmission mounting holes 14 of backing plate 10 are positioned to align with the bolt pattern of the engine end of the 350 transmission bell housing. The 350 transmission bell housing is bolted to backing plate 10. This places the torque converter of the transmission proximate flywheel 50. The crankshaft of the S4S engine is then rotated so that one of the torque converter mounting holes 58 of flywheel 50 is reachable through access hole 13 of backing plate 10. The torque converter is rotated as necessary to align the bolt holes in the torque converter with torque converter mounting holes 58. Utilizing access hole 13, a bolt is inserted through torque converter mounting holes 58 and secured to the torque converter. Flywheel 50 is then rotated 120 degrees and the process is repeated. Flywheel 50 is rotated 120 degrees again and a final bolt is secured to the torque converter. A plug is then inserted into access hole 13 of backing plate 10 to keep dirt and debris out of the interior of the 350 transmission bell housing.

The 350 transmission has then been coupled to the S4S engine via adapter kit 100. It should be understood that additional steps for coupling an engine to a transmission known or readily apparent to one of ordinary skill in the art have been left out of this example.

Turning now to benefits of embodiments of the present invention. One benefit may be that the engine compartment of vehicle 1 may not have to be increased in size. The distance between engine 2 and transmission 3 may be determined by the thickness of backing plate 10 of adapter kit 100. Thus, in certain embodiments, the distance between engine 2 and transmission 3 may be only ⅜ or ½ an inch. If the length of engine 2 is similar or less than the length of the engine vehicle 1 was designed for use with, then the engine compartment may not have to be increased in size. Therefore, utilizing adapter kit 100 may save thousands of dollars compared to an adapter kit that would require enlargement of the engine compartment.

Another benefit of adapter kit 100 is that it may be almost entirely manufactured from metal plates. For example, backing plate 10, holding means 30, crankshaft spacer means 40, plate member 51 of flywheel 50, and starter spacer means 60 may all be cut from steel plates. This may simplify and reduce the cost of adapter kit 100 compared to an adapter kit utilizing cast or machined housings.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A kit for coupling an engine to a transmission, said kit including a backing plate having an engine side and a transmission side, said backing plate comprising:
a crankshaft hole having a center axially aligned with a crankshaft flange extending from a rear face of said engine, said crankshaft hole having a diameter of sufficient width to receive a seal means for forming a seal between said crankshaft hole and said crankshaft flange;
engine mounting means for mounting the engine side of said backing plate to the rear face of said engine; and
transmission mounting means for mounting the transmission side of said backing plate to the engine end of a transmission bell housing of said transmission, at least a portion of the engine mounting means located between the transmission mounting means and the crankshaft hole.

2. The kit of claim 1, further comprising:
a flywheel having a thickness and diameter compatible with the inner dimensions of said transmission bell housing, said flywheel configured for attachment to said crankshaft flange.

3. The kit of claim 2, wherein said flywheel is configured for attachment to a torque converter housed within said transmission bell housing.

4. The kit of claim 2, wherein the backing plate further comprises an access hole located between said transmission mounting means and said engine mounting means, said access hole having sufficient diameter to allow tool access to said flywheel when said transmission bell housing is attached to said backing plate.

5. The kit of claim 4, wherein said access hole has a diameter of about 1½ inch.

6. The kit of claim 2, wherein said backing plate further comprises a starter hole to allow starter access to a ring gear of said flywheel.

7. The kit of claim 6, further comprising a starter spacer means for appropriately aligning a starter with said ring gear.

8. The kit of claim 7, wherein said starter spacer means comprises a plate including a C-shaped member, wherein the inner perimeter of the closed portion of said C-shaped member is equal to the inner radius of said starter hole in said backing plate.

9. The kit of claim 1, wherein the backing plate has a thickness of about ⅜ of an inch to about ½ an inch.

10. The kit of claim 1, further comprising a holding means for holding said seal means in place.

11. The kit of claim 10, wherein said holding means comprises an annular ring comprising:
an inner diameter able to circumscribe said crankshaft flange without contacting said crankshaft flange;
an outer diameter wider than the diameter of said crankshaft hole; and
means for attaching said holding means to said backing plate.

12. The kit of claim 1, further comprising a crankshaft spacer means for axially spacing a flywheel relative to a torque converter.

13. The kit of claim 12, wherein said crankshaft spacer means includes an annular ring comprising:
an outer diameter equal to the outer diameter of said crankshaft flange;
an inner diameter equal to the diameter of a hub located in the axial center of the end of said crankshaft flange; and
bolt holes aligned to correspond to bolt holes formed in said end of said crankshaft flange.

14. A vehicle comprising an incompatible engine and transmission, said engine having a crankshaft flange of a crankshaft extending beyond a rear face of said engine, said transmission having a transmission bell housing, said vehicle comprising:
a backing plate having an engine side and a transmission side, said engine side bolted to said rear face of said engine via engine mounting holes in said backing plate, said transmission side bolted to said engine end of said transmission bell housing via transmission mounting holes in said backing plate, said backing plate further comprising:
a crankshaft hole having a center axially aligned with a crankshaft flange of said crankshaft, said crankshaft hole having a diameter of sufficient width to receive a seal means for forming a seal between said crankshaft hole and said crankshaft flange; and
an access hole located between the pattern of said engine mounting holes and the pattern of said transmission mounting holes to give tool access to the interior of said transmission bell housing.

15. The vehicle of claim 14, wherein said seal means comprises the rear main seal originally supplied with said engine.

16. The vehicle of claim 14, further comprising a holding means for holding the sealing means in place.

17. The vehicle of claim 14, further comprising:
a flywheel having a thickness and diameter compatible with the inner dimensions of said transmission bell housing, said flywheel attached to said crankshaft flange and attached to a torque converter housed within said transmission bell housing.

18. The vehicle of claim 17, further comprising a crankshaft spacer means for appropriately spacing said flywheel from the end of said crankshaft flange to allow for the necessary travel of said torque converter attached to said flywheel.

19. The vehicle of claim 17, further comprising:
a starter;
a starter hole formed in said backing plate for allowing access of said starter to a ring gear of said flywheel;
a starter spacer means for appropriately spacing said starter from said ring gear of said flywheel, said starter spacer means sandwiched between said starter and said engine side of said backing plate, said starter bolted through said starter spacer plate to said backing plate.

20. A kit for coupling an incompatible engine and automatic transmission, said engine having a crankshaft flange of a crankshaft extending beyond a rear face of said engine, said automatic transmission having a transmission bell housing, said kit comprising:
a backing plate having an engine side and a transmission side, said backing plate comprising:
a crankshaft hole having a center axially aligned with a crankshaft flange of said crankshaft, said crankshaft hole having a diameter of sufficient width to receive a seal means for forming a seal between said crankshaft hole and said crankshaft flange;
engine mounting holes aligned with a bolt pattern of a rear face of said engine;
transmission mounting holes aligned with a bolt pattern of an engine end of said transmission bell housing, the pattern of said engine mounting holes located within the pattern of said transmission mounting holes; and
an access hole located between the pattern of said engine mounting holes and the pattern of said transmission mounting holes and sized to allow access to the interior of a transmission bell housing upon installation of the kit;
a flywheel having a thickness and diameter compatible with the inner dimensions of said transmission bell housing, said flywheel configured for attachment to said crankshaft flange;
a crankshaft spacer means for spacing said flywheel from the end of said crankshaft;
a holding means for holding said seal means in place; and
a starter spacer means for spacing a starter from said engine side of said backing plate.
